(19) United States
(12) Patent Application Publication
(10) Pub. No.: US 2016/0237754 A1
(43) Pub. Date: Aug. 18, 2016

(54) BICOMPONENT SEALS COMPRISING ALIGNED ELONGATED CARBON NANOPARTICLES

(71) Applicant: Halliburton Energy Services, Inc., Houston, TX (US)

(72) Inventor: Ping Sui, (US)

(73) Assignee: Hallivurton Energy Services, Inc., Houston, TX (US)

(21) Appl. No.: 14/371,357

(22) PCT Filed: Aug. 27, 2013
(86) PCT No.: PCT/US2013/056715

§ 371 Date: Jul. 9, 2014

(51) Int. Cl. E21B 10/24; F16J 15/3284; B32B 25/04; C10M 103/02; B32B 5/16; B32B 25/02; F16J 15/324; E21B 10/25

(52) U.S. Cl. CPC E21B 10/24; F16J 15/324; F16J 15/3284; E21B 10/25; C10M 103/02; B32B 5/16; B32B 25/02; B32B 25/042; E21B 2010/225

(57) ABSTRACT

Some embodiments described herein provide a bicomponent seal comprising an outer sheath comprising a nanocomposite material comprising aligned elongated carbon nanoparticles embedded in a first polymer; and an inner core comprising a second polymer. In some embodiments, the elongated carbon nanoparticles may be selected from the group consisting of graphene nanoribbons; carbon nanotubes; carbon nanohorns; and any combination thereof.

### BACKGROUND

The methods of the embodiments relate to bicomponent seals comprising elongated carbon nanoparticles, methods for their manufacture, and methods for their use in equipment enduring rotational, frictional, compressional, rotational, or other forces causing wear to the equipment.

Components of equipment used in various industries, such as oil and gas, mining, chemical, pulp and paper, converting, aerospace, medical, automotive, experience various types of mechanical wear, resulting in the physical removal of a material from one solid surface by another solid surface or material. Typically, such mechanical wear is caused by two solid surfaces, such as metal surfaces, that are in frequent motion against one another, by hard materials moving along a solid surface causing gouging, chipping, or cracking, by particulates in a fluid stream impacting a solid surface causing erosion of a portion of the solid surface, or by repeated motion of a solid surface resulting in stress loads and cracks below the surface of the solid surface that may spread thereafter.

Mechanical wear is particularly concerning in subterranean formation operations, such as drilling operations, where a drilling tool having drill bit (e.g., roller cone or fixed drill bit) is lowered into a wellbore for cutting through rock. Generally, the drilling tool is operated until the drilling cutters on the drill bit are excessively worn. Thereafter, it is necessary to remove the entire drilling tool assembly and replace the drill bit. Such removal of the drilling tool assembly is economically burdensome, as it results in nonproductive time. Moreover, the need to often change the drill bit causes increased equipment costs.

The operational lifetime of a drill bit has been traditionally enhanced by lubricating the bearings and other parts of the bit that are affected by metal-on-metal forces resulting in mechanical wear. The operational lifetime of a drill bit may additionally be enhanced by including sealing components between solid surface components, which are typically metal surfaces, or between components that may encounter a particulate fluid stream to prevent ingress of abrasive particulates (e.g., drill cuttings, formation particulates, particulates in the drilling fluid, and the like) or corrosive materials into crevasses between components of the drill bit. Loss of the lubricant or the sealing component may result in substantial shortening of the lifetime of a drill bit. Moreover, the cost associated with replacing lubricant and/or sealing components may be rather high, in both economic and time expenditures.

### BRIEF DESCRIPTION OF THE DRAWINGS

The following figures are included to illustrate certain aspects of the embodiments described herein, and should not be viewed as exclusive embodiments. The subject matter disclosed is capable of considerable modifications, alterations, combinations, and equivalents in form and function, as will occur to those skilled in the art and having the benefit of this disclosure.

FIG. 1 provides a diagram of a roller cone drill bit.

FIG. 2 provides a diagram of a drilling rig for drilling a wellbore into a subterranean formation.

FIG. 3 provides a cross-sectional diagram of a portion of a roller cone bit comprising a bicomponent seal according to at least one embodiment described herein.

FIG. 4a provides cross-sectional diagram of a bicomponent seal described herein.

FIG. 4b provides a view of functionalized aligned elongated carbon nanoparticles in a nanocomposite material according to some embodiments described herein.

### DETAILED DESCRIPTION

The methods of the embodiments described herein relate to bicomponent seals comprising elongated carbon nanoparticles, methods for their manufacture, and methods for their use in equipment enduring rotational, frictional, compressional, rotational, or other forces causing wear to the equipment.

Although the embodiments disclosed herein focus on providing bicomponent seals comprising elongated carbon nanoparticles for use in drill bits used in subterranean formation drilling operations, the bicomponent seals may be effectively used in any equipment that has components which experience mechanical wear. Such equipment may be used in any industry including, but not limited to, oil and gas, mining, chemical, pulp and paper, converting, aerospace, medical, automotive, and the like. The bicomponent seals of the embodiments disclosed herein may be adaptable to any shape or size necessary for use in a particular equipment type and are not confined to any particular shape or size described herein. For example, the bicomponent seals of the embodiments described herein may be round-shaped seals (e.g., O-ring), high aspect ratio seals, radial seals, axial seals, D-shaped seals, flatten-shaped seals, lipped-shaped seals, custom lathe-cut seals, or any other seal shape that may benefit from increased lubricity. Thus, the inner core or outer core may take on these shapes and the embodiments disclosed herein are not limiting on any such shape. The bicomponent seals of the embodiments of this disclosure may be used for static sealing or dynamic sealing.

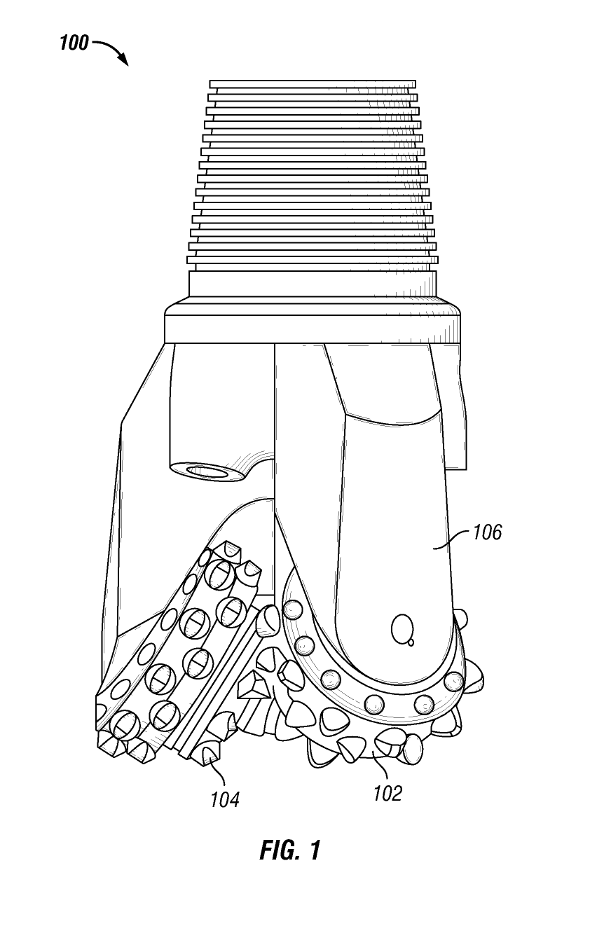

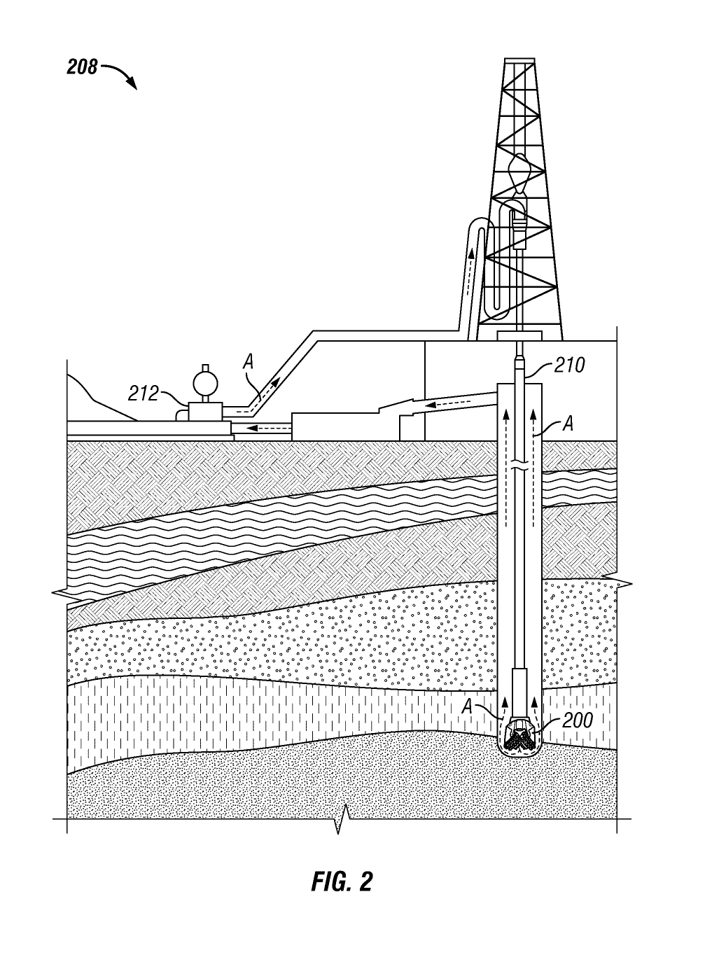

An important type of drill bit used in wellbore drilling is the roller cone drill bit, illustrated in FIG. 1 as 100. In a roller cone drill bit, rotating cones 102 have inserts 104 on their outer surface and is mounted on arm 106 of the drill bit body. During drilling, as illustrated in FIG. 2, a drill rig 208 uses sections of pipe 210 transfer rotational force to the drill bit 200 and pump 212 to circulate drilling fluid (as illustrated as flow arrows A) to the bottom of the wellbore through the sections of pipe 210. As the drill bit rotates, the applied weight-on-bit (“WOB”) forces the downward pointing inserts of the rotating cones into the formation being drilled. Thus, the points of the inserts apply a compressive stress which exceeds the yield stress of the formation, causing a wellbore to be formed. The resulting fragments (also referred to as “cuttings”) are flushed away from the cutting face by a high flow of drilling fluid (also referred to as “mud”).

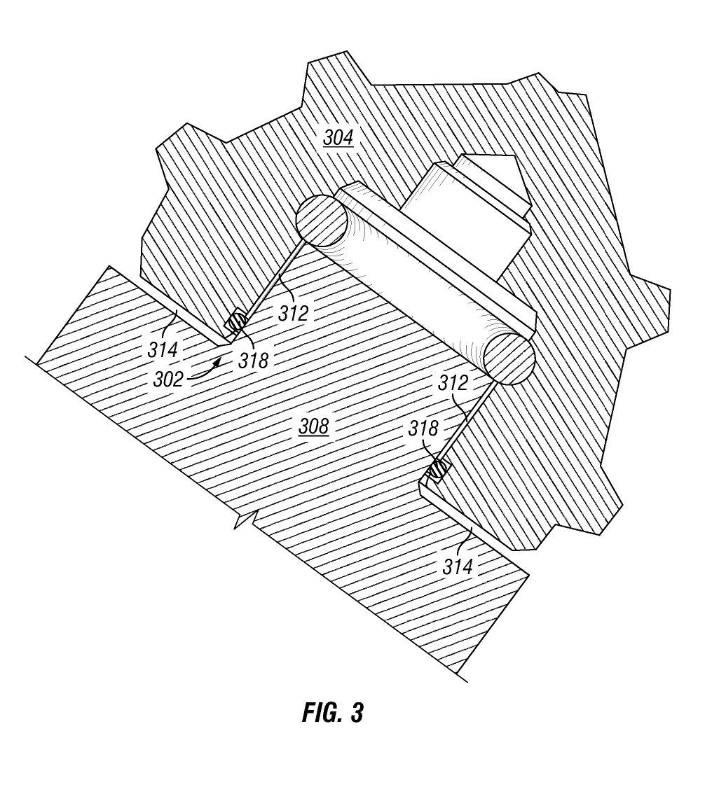

Referring now to FIG. 3, a cross-sectional diagram of a portion of a roller cone drill bit, rotary joint 302 is defined by two elements: first element 304 illustrated as a roller cone and second element 308 illustrated as a support arm with spindle. The bicomponent seal according to at least one embodiment described herein is illustrated as 318 is configured to seal a portion of the rotary joint 302, thereby defining sealed segment 312 and unsealed segment 314. Bicomponent seal 308 provides lubricity to the rotary joint 302 and prevents ingress of particulates into sealed segment 312.

In some embodiments, the bicomponent seals of the embodiments disclosed herein comprise an outer sheath and an inner core, wherein the outer sheath comprises aligned elongated carbon nanoparticles, and wherein the inner core comprises a polymer. In other embodiments, the outer sheath comprises a nanocomposite material comprising aligned elongated carbon nanoparticles embedded in a polymer. In still other embodiments, the inner core of the bicomponent seals of the embodiments described herein may comprise a nanocomposite material comprising elongated carbon nanoparticles that is either aligned or randomly embedded therein. As used herein, the term “aligned” refers to the orientation of the elongated carbon nanoparticles in the same directional plane (e.g., in the axial direction or the radial direction). Such alignment may have significant impact on the sealing efficiency, lubricity, and longevity of the bicomponent seal, as well as a significant impact on the ability of the elongated carbon nanoparticles to impart lubricity to the bicomponent seal and the longevity of the elongated carbon nanoparticles themselves.

Elongated carbon nanoparticles may take multiple forms, such as, for example, graphene nanoribbons; carbon nanotubes; and carbon nanohorns. Graphene nanoribbons (“GNRs”) are long strips of graphene formed from unzipped carbon nanotubes that may be from about 5 nm to about 50 nm wide, and from about 100 nm to about 2 μm long. In other embodiments, GNRs may be from about 5 nm to about 30 nm wide, and from about 500 nm to about 1 μm long. In still other embodiments, GNRs may be from about 5 nm to about 30 nm wide, and from about 100 nm to about 500 nm long. The width and length ranges of the graphene nanoribbons disclosed herein may be any size outside of these ranges based on certain factors known by those of ordinary skill in the art including, but not limited to, the size and shape of the bicomponent seal, the method of synthesis of the graphene nanoribbon, the amount of lubricity desired, and the like. As used herein, the term “graphene nanoribbons” and “graphene” encompasses few-layered graphene nanoribbons. Carbon nanotubes are allotropes of carbon having a cylindrical structure. For use in the embodiments described herein, such carbon nanotubes may be single-walled carbon nanotubes (“SWNTs”) or multi-walled carbon nanotubes (“MWNTs”) (e.g., having 2 to 50 or more walls than SWNTs). Carbon nanohorns (“CNHs”) are allotropes of carbon and, similar to carbon nanotubes, are elongated, predominantly cylindrical structures with tapered or horn-like ends. In some embodiments, the elongated carbon nanoparticles may be present in the nanocomposite materials of the embodiments described herein in an amount in the range of from about 1% to about 80% of the polymer host. In other embodiments, the elongated carbon nanoparticles may be present in the nanocomposite materials of the embodiments described herein in an amount in the range of from about 15% to about 50% of the polymer host.

Elongated carbon nanoparticles may impart lubricity to the bicomponent seals of the embodiments described herein, as they may drastically reduce the coefficient of friction of many metals, thus reducing mechanical wear. The reduced coefficient of friction may be attributed to the low shear nature of the elongated carbon nanoparticles. Additionally, the elongated carbon nanoparticles may prevent or reduce metal oxidation (e.g., corrosion) when present at sliding contact surfaces. Due to the tensile strength of elongated carbon nanoparticles, their inclusion in the bicomponent seals described herein may further aid in prolonging mechanical wear on equipment components in contact with the bicomponent seals, as well as aid in prolonging wear of the bicomponent seal itself. The attributes of the elongated carbon nanoparticulates may also aid in preventing the ingress of abrasive and corrosive particulates in unwanted portions of equipment and imparting longer lasting sealing capacity. The attributes of the elongated carbon nanoparticulates may additionally improve the elastic property of the bicomponent seals described in some embodiments herein and better preserve its life in elevated temperature environments, an improvement that enhances sealing performance as well as prolongs the life of the bicomponent seal. Moreover, the alignment of the elongated carbon nanoparticles may further aid in imparting lubricity to the outer sheath of the bicomponent seal as it permits mechanical components of an equipment to encounter an increased surface area of the elongated carbon nanoparticles than would be the case if the nanoparticles were not aligned. The bicomponent seals of the embodiments described herein are particularly beneficial for dynamic sealing.

The elongated carbon nanoparticles for use in the outer sheath and, optionally, the inner core of the bicomponent seals of the embodiments described herein, either alone or in a nanocomposite, may be synthesized (or “grown”) by any means known in the art. Elongated carbon nanoparticles may be synthesized by methods including, but not limited to, epitaxial growth substrates (e.g., ruthenium, iridium, nickel, copper, cobalt, chromium, stainless steel, silicon carbide, titania, alumina, silica, sapphire, and the like); chemical vapor deposition; laser ablation; arc discharge; plasma torch; nanotube unzipping; and the like.

The bicomponent seals may have an inner core comprising a polymer. The polymer may impart structure and rigidity to the bicomponent seal. Moreover, the polymer may be selected so as to maintain stability at high temperatures, such as those encountered in a subterranean formation (e.g., while drilling a wellbore). In some embodiments, the inner core of the bicomponent seals may be a nanocomposite material, comprising the polymers described herein embedded with the elongated carbon nanoparticles described herein, either aligned or randomly embedded. The addition of the elongated nanoparticles may impart additional rigidity and/or heat resistance to the inner core of the bicomponent seals. For this reason, it may be preferred that the polymer, elongated carbon nanoparticles, and/or orientation of the elongated carbon nanoparticles (e.g., aligned or randomly embedded) of the nanocomposite material of the inner core differ from that of the nanocomposite material of the outer sheath, so as to form a bicomponent seal having a more structurally rigid and/or heat resistant inner core compared to its outer sheath. One of ordinary skill in the art, with the benefit of this disclosure, will recognize whether to alter the polymer type, elongated carbon nanoparticle type, orientation of the elongated carbon nanoparticles, or any combination thereof of the nanocomposite material of the inner core or outer sheath so as to achieve the desired results.

In some embodiments, the polymer in the inner core may be an elastomer. Suitable elastomers may include, but are not limited to acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; and any combination thereof. The term “derivative” is defined herein as any compound that is made from one of the listed compounds, for example, by replacing one atom in one of the listed compounds with another atom or group of atoms, ionizing one of the listed compounds, or creating a salt of one of the listed compounds.

In some embodiments, the polymer in the nanocomposite material of outer sheath may be an elastomer. Suitable elastomers may include, but are not limited to acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; and any combination thereof. The term “derivative” is defined herein as any compound that is made from one of the listed compounds, for example, by replacing one atom in one of the listed compounds with another atom or group of atoms, ionizing one of the listed compounds, or creating a salt of one of the listed compounds.

In those embodiments where the outer sheath of the bicomponent seals comprise a nanocomposite material comprising aligned elongated carbon nanoparticles embedded in a polymer, the elongated carbon nanoparticles may be functionalized so as to aid in embedding the elongated carbon nanoparticles into the polymer. The nanocomposite material comprising the inner core in some embodiments of the embodiments described herein may also comprise functionalized elongated carbon nanoparticles to aid in embedding them into the polymer, either aligned or random orientation. The elongated carbon nanoparticles of the embodiments described herein may comprise oxygen-containing functional groups (e.g., —OH, —COOH, and the like) that may beneficially serve as chemical handles for functionalization to aid in solubilizing the elongated nanoparticles into the nanocomposite materials of the embodiments described herein. Functionalization may be accomplished by use of any moiety that aids in forming the nanocomposite materials for use in the bicomponent seals of the embodiments described herein (including both the inner core and outer sheath) that permits or enhances incorporation of the elongated carbon nanoparticles into the polymer host. In some embodiments, the elongated carbon nanoparticles may be functionalized with any of the polymers used in the bicomponent seals disclosed herein. In some preferred embodiments, the elongated carbon nanoparticles may be functionalized with the polymer into which they are to be embedded. In other preferred embodiments, the elongated carbon nanoparticles may be functionalized with a reduced molecular weight counterpart of the polymer into which they are to be embedded (e.g., an oligomer or derivative of the polymer). As used herein, the term “oligomer” refers to a polymerized compound whose backbone is from 2 to 25 monomers. Suitable functionalization may be achieved with polymers or oligomers of acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; any oligomer thereof; and any combination thereof.

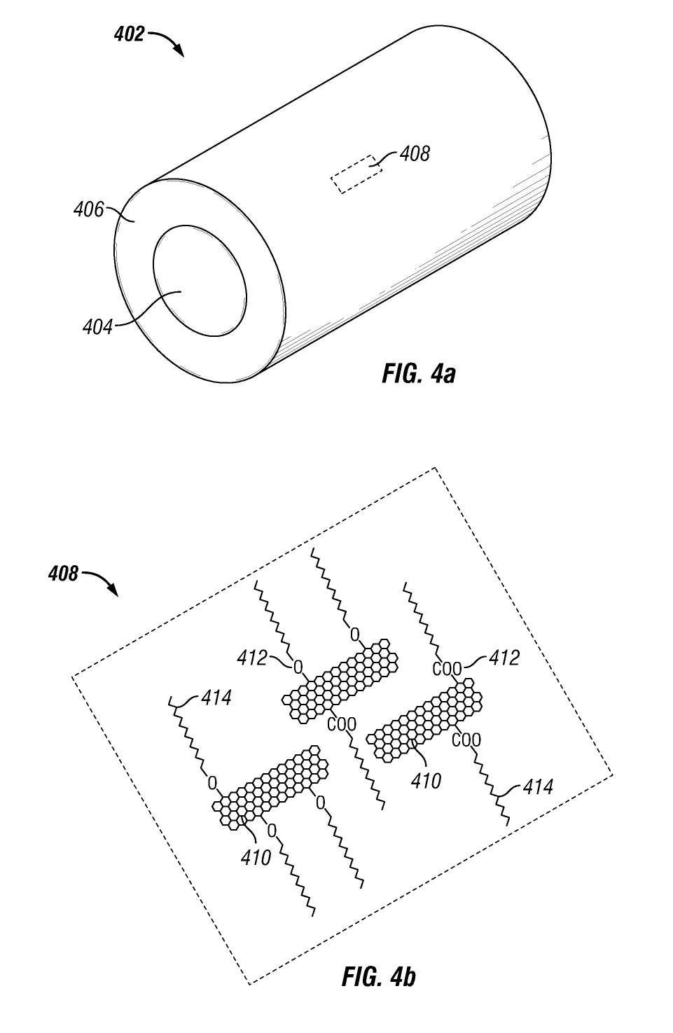

The elongated carbon nanoparticles forming the outer sheath of the bicomponent seal, either alone or in the nanocomposite material (aligned or randomly embedded), may impart lubricity to the seal. The alignment of the elongated carbon nanoparticles may further aid in imparting lubricity to the outer sheath of the bicomponent seal as it permits mechanical components of an equipment to encounter an increased surface area of the elongated carbon nanoparticles, than would be the case if the nanoparticles were not aligned. Referring now to FIG. 4a, a cross-section of bicomponent seal 402 in accordance with some of the embodiments disclosed herein is shown, having inner core 404 and outer sheath 406. A portion of outer sheath 408 is shown in detail in FIG. 4b. Elongated carbon nanoparticles, 410 have chemical handles 412 and is functionalized with polymers or oligomers 414. The polymers or oligomers 414 entangle with the polymer in the outer sheath, such that the elongated carbon nanoparticles are embedded therein.

In some embodiments, the size of the bicomponent seal is designed such that a cross-sectional view yields an inner core comprising about 90% to about 50% of the length of the cross-section and an outer sheath comprises about 10% to about 50% of the length of the cross-section. Thus, the outer sheath may form about 5% to about 25% of the length of the cross-section of the bicomponent seal on either side of the inner core because the outer sheath surrounds the inner core. The size of the inner core may be dependent upon, for example, the need for structural rigidity and stability in heat or other subterranean formation conditions. The size of the outer sheath may be dependent upon, for example, the enhanced lubricity and sealing capacity of the bicomponent seal and the duration of use of the subterranean equipment into which it is incorporated. One of ordinary skill in the art, with the benefit of this disclosure will recognize what size to make the inner core and outer sheath of the bicomponent seals of the embodiments described herein, within the parameters described herein, for use in a particular application.

The bicomponent seals of the embodiments described herein may be formed by any known method in the art for forming sealing components. Suitable methods of making the bicomponent seals of the embodiments described herein include, but are not limited to, coextruding the outer sheath and inner core; melt deposition the outer sheath onto the inner core; static or rotational layer deposition of the outer sheath onto the inner core; and any combination thereof. Coextruding the outer sheath and the inner core may facilitate alignment of the elongated carbon nanoparticles, where applicable. In preferred embodiments, the bicomponent seals are made by melt deposition or static or rotational layer deposition of the outer sheath onto the inner core, as such methods may be performed without causing the presence of a fastening seam in the bicomponent seal itself which may reduce the seals resistance to mechanical wear. Melt deposition may be achieved by first forming the inner core and then dipping it into the outer sheath in melt form or placed it into a mold having the outer sheath material in melt form, such that the outer core material in melt form surrounds the inner core and then cures to form the bicomponent seal. The melt state of the outer core may facilitate alignment of the elongated carbon nanoparticles. Static layer deposition of the outer sheath may be achieved by first forming the inner core and the slowly layering the outer sheath onto the inner core, a method that may facilitate alignment of the elongated carbon nanoparticles, where applicable. Rotational layer deposition of the outer sheath may be achieved by first forming the inner core and rotating or spinning the outer sheath such that it is deposited onto the inner core in a spiral-like manner, which may facilitate alignment of the elongated carbon nanoparticles, where applicable.

Embodiments disclosed herein include:

A. A bicomponent seal comprising: an outer sheath comprising a nanocomposite material comprising aligned elongated carbon nanoparticles embedded in a first polymer; and an inner core comprising a second polymer.

B. A bicomponent seal comprising: an outer sheath comprising a first nanocomposite material comprising aligned elongated carbon nanoparticles embedding in a first polymer; and an inner core comprising a second nanocomposite material comprising elongated carbon nanoparticles embedded in a second polymer.

C. A drill bit comprising: a rotary joint; and a bicomponent seal configured to seal a portion of the rotary joint, thereby defining a sealed segment and an unsealed segment of the rotary joint, wherein the bicomponent seal comprises an outer sheath comprising a nanocomposite material comprising aligned elongated carbon nanoparticles embedded in a first polymer and an inner core comprising a second polymer.

Each of embodiments A, B, and C may have one or more of the following additional elements in any combination

Element 1: Wherein the elongated carbon nanoparticles are selected from the group consisting of graphene nanoribbons; carbon nanotubes; carbon nanohorns; and any combination thereof.

Element 2: Wherein the first polymer and the second polymer are elastomers selected from the group consisting of acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; and any combination thereof.

Element 3: Wherein the first polymer and the second polymer are different elastomers.

Element 4: Wherein the elongated carbon nanoparticles in the bicomponent seal are functionalized with acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; any oligomer thereof; and any combination thereof.

Element 5: Wherein the first polymer is an elastomer, and wherein the elongated carbon nanoparticles are functionalized with the same elastomer or an oligomer thereof.

Element 6: Wherein the inner core of the bicomponent seal comprises about 90% to about 50% of a cross-section length, and wherein the outer sheath comprises about 10% to about 50% of the cross-section length.

Element 7: Wherein elongated carbon nanoparticles in the second nanocomposite material are aligned.

Element 8: Wherein the first polymer is an elastomer, and wherein the elongated carbon nanoparticles in the first nanocomposite material are functionalized with the same elastomer or an oligomer thereof.

Element 9: Wherein the second polymer is an elastomer, and wherein the elongated carbon nanoparticles in the second nanocomposite material are functionalized with the same elastomer or an oligomer thereof

Element 10: Wherein the first polymer is a first elastomer, and wherein the elongated carbon nanoparticles in the first nanocomposite material are functionalized with the same first elastomer or an oligomer thereof, wherein the second polymer is a second elastomer, and wherein the elongated carbon nanoparticles in the second nanocomposite material are functionalized with the same second elastomer or an oligomer thereof, and wherein the first elastomer and the second elastomer are different.

By way of non-limiting example, exemplary combinations applicable to A, B, C include: A in combination with 3, 4, and 6; B in combination with 1, 5, 6, and 7; and C in combination with 4 and 10.

Therefore, the embodiments described herein are well adapted to attain the ends and advantages mentioned as well as those that are inherent therein. The particular embodiments disclosed above are illustrative only, as the embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the embodiments described herein. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A bicomponent seal comprising:
an outer sheath comprising a nanocomposite material comprising aligned elongated carbon nanoparticles embedded in a first polymer; and
an inner core comprising a second polymer.

2. The bicomponent seal of claim 1, wherein the elongated carbon nanoparticles are selected from the group consisting of graphene nanoribbons; carbon nanotubes; carbon nanohorns; and any combination thereof.

3. The bicomponent seal of claim 1, wherein the first polymer and the second polymer are elastomers selected from the group consisting of acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; and any combination thereof.

4. The bicomponent seal of claim 1, wherein the first polymer and the second polymer are different elastomers.

5. The bicomponent seal of claim 1, wherein the elongated carbon nanoparticles are functionalized with acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; any oligomer thereof; and any combination thereof.

6. The bicomponent seal of claim 1, wherein the first polymer is an elastomer, and wherein the elongated carbon nanoparticles are functionalized with the same elastomer or an oligomer thereof.

7. The bicomponent seal of claim 1, wherein the inner core of the bicomponent seal comprises about 90% to about 50% of a cross-section length, and wherein the outer sheath comprises about 10% to about 50% of the cross-section length.

8. A bicomponent seal comprising:
an outer sheath comprising a first nanocomposite material comprising aligned elongated carbon nanoparticles embedding in a first polymer; and
an inner core comprising a second nanocomposite material comprising elongated carbon nanoparticles embedded in a second polymer.

9. The bicomponent seal of claim 8, wherein the elongated carbon nanoparticles in the first nanocomposite material and the elongated carbon nanoparticles in the second nanocomposite are selected from the group consisting of graphene; graphene nanoribbons; carbon nanotubes; carbon nanohorns; and any combination thereof.

10. The bicomponent seal of claim 8, wherein elongated carbon nanoparticles in the second nanocomposite material are aligned.

11. The bicomponent seal of claim 8, wherein the first polymer and the second polymer are elastomers selected from the group consisting of acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; and any combination thereof.

12. The bicomponent seal of claim 8, wherein the elongated carbon nanoparticles in the first nanocomposite material and the elongated carbon nanoparticles in the second nanocomposite are functionalized with acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; any oligomer thereof; and any combination thereof.

13. The bicomponent seal of claim 8, wherein the first polymer is an elastomer, and wherein the elongated carbon nanoparticles in the first nanocomposite material are functionalized with the same elastomer or an oligomer thereof.

14. The bicomponent seal of claim 8, wherein the second polymer is an elastomer, and wherein the elongated carbon nanoparticles in the second nanocomposite material are functionalized with the same elastomer or an oligomer thereof.

15. The bicomponent seal of claim 8, wherein the first polymer is a first elastomer, and wherein the elongated carbon nanoparticles in the first nanocomposite material are functionalized with the same first elastomer or an oligomer thereof,
wherein the second polymer is a second elastomer, and wherein the elongated carbon nanoparticles in the second nanocomposite material are functionalized with the same second elastomer or an oligomer thereof,
and wherein the first elastomer and the second elastomer are different.

16. The bicomponent seal of claim 8, wherein the inner core of the bicomponent seal comprises about 90% to about 50% of a cross-section length, and wherein the outer sheath comprises about 10% to about 50% of the cross-section length.

17. A drill bit comprising:
a rotary joint; and
a bicomponent seal configured to seal a portion of the rotary joint, thereby defining a sealed segment and an unsealed segment of the rotary joint,
wherein the bicomponent seal comprises an outer sheath comprising a nanocomposite material comprising aligned elongated carbon nanoparticles embedded in a first polymer and an inner core comprising a second polymer.

18. The drill bit of claim 17, wherein the elongated carbon nanoparticles are selected from the group consisting of graphene nanoribbons; carbon nanotubes; carbon nanohorns; and any combination thereof.

19. The drill bit of claim 17, wherein the first polymer and the second polymer are elastomers selected from the group consisting of acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; and any combination thereof.

20. The method of claim 17, wherein the first polymer and the second polymer are different elastomers.

21. The drill bit of claim 17, wherein the elongated carbon nanoparticles are functionalized with acrylonitrile-butadiene; carboxylated acrylonitrile-butadiene; hydrogenated acrylonitrile-butadiene; carboxylated hydrogenated acrylonitrile-butadiene; carboxylated nitrile; hydrogenated nitrile butadiene; isobutylene-isoprene; polyisobutylene; poly(2-chlorobuta-1,3-diene); ethylene acrylate; ethylene-propylene; ethylene-propylenediene; fluorocarbon; polysiloxane; fluorinated polysiloxane; perfluoroelastomer; polyacrylate; polyester urethane; polyether urethane; styrene-butadiene; tetrafluoroethylene-propylene; any derivative thereof; any oligomer thereof; and any combination thereof.

22. The drill bit of claim 17, wherein the first polymer is an elastomer, and wherein the elongated carbon nanoparticles are functionalized with the same elastomer or an oligomer thereof.

23. The drill bit of claim 17, wherein the inner core of the bicomponent seal comprises about 90% to about 50% of a cross-section length, and wherein the outer sheath comprises about 10% to about 50% of the cross-section length.
